(19) United States
(12) Patent Application Publication
(10) Pub. No.: US 2013/0131920 A1
(43) Pub. Date: May 23, 2013

(54) METHOD FOR OPERATING A MOTOR VEHICLE AND MOTOR VEHICLE

(71) Applicants: Karl-Heinz Meitinger, Munchen (DE); Peter Kunsch, Karlskron (DE); Dirk Isgen, Gaimersheim (DE); Michael Wein, Seubersdorf (DE); Tilo Koch, Ingolstadt (DE)

(72) Inventors: Karl-Heinz Meitinger, Munchen (DE); Peter Kunsch, Karlskron (DE); Dirk Isgen, Gaimersheim (DE); Michael Wein, Seubersdorf (DE); Tilo Koch, Ingolstadt (DE)

(73) Assignee: AUDI AG, Ingolstadt (DE)

(21) Appl. No.: 13/699,219

(22) PCT Filed: Apr. 12, 2011
(86) PCT No.: PCT/EP2011/001801

§ 371 Date: Jan. 10, 2013

(30) Foreign Application Priority Data
May 21, 2010 (DE) 10 2010 021 210.5

(51) Int. Cl. B62D 17/00

(52) U.S. Cl. CPC B62D 17/00
USPC 701/36

(57) ABSTRACT

A motor vehicle can have multiple drive modes, for example rear wheel drive, four wheel drive, front wheel drive. Here, an active chassis device is used to make different adjustments, for example with respect to the toe-in angle and the camber angle, of a wheel or else with respect to wheel loads as a function of the drive load. As a result, the driving behaviour can be matched in each case in an optimum way to the drive mode, or conversely can be configured in such a way that changing the drive mode does not have a perceptible effect for the driver.

The invention relates to a method for operating a motor vehicle, which is drivable in at least two drive modes, wherein these modes differ with regard to at least one wheel, regarding whether this wheel is driven or not. It relates also to a motor vehicle.

Known drive modes are for example the front wheel drive, rear wheel drive or all wheel drive.

A prerequisite of the motor vehicle is also that it has a so called active chassis, i.e. that a chassis device can be adjusted during operation of the motor vehicle.

In order for a motor vehicle driver to safely drive a motor vehicle, he must develop a sense for the motor vehicle and its handling characteristics. For example, it is important that the driver is familiar with the so called self-steering behavior of the motor vehicle. This can be quantitatively expressed by the self-steering gradient. This is a key figure which, for the condition that the motor vehicle drives in a circle with constant radius, represents the ratio of the angle by which the steering wheel has to be turned to the speed of the motor vehicle. In case of a so called under-steering, the vehicle driver has to steer more than would actually be required, in case of an over-steering he has to steer less.

A vehicle driver who is familiar with his motor vehicle, is adapted to the under-steering or over-steering.

It may be the case that the drive mode is changed in conjunction with the same driver. This may occur due to a driver input. However, a control unit may also cause a change of the drive mode; this is for example frequently the case in hybrid vehicles which, in addition to an internal combustion engine, have an electric drive, which is switched on or off depending on the need.

The vehicle driver should not be placed in a dangerous situation as a result of such a change of the drive mode due to a driving behavior of the motor vehicle to which the driver is not used, or also merely perceives driving the motor vehicle as uncomfortable for example associated with the feeling of insecurity.

It is the object of the invention to propose a way how to increase safety when driving a motor vehicle.

The object is solved with regard to the method by the subject matter of patent claim 1, with regard to the motor vehicle by the subject matter of patent claim 8.

In the method according to the invention, it is thus taken advantage of the fact that the chassis device is an active one: When changing the drive mode, an automatic change with regard to at least one setting which is possible at the motor vehicle occurs.

In other words, the communication of the type of drive mode is an input value for the active chassis device. Then, the setting at the chassis device can be configured so as to increase safety for the driver.

In an active chassis, the toe-in and/or camber angle can be changed at at least one wheel of the motor vehicle. These determine the self-steering behavior.

In the same manner it is also possible to change a wheel load (force) through the active chassis device on at least one wheel on which the wheel load acts. According to DE 10 2007 060 876 A1, this can for example occur by way of an electromagnetic transducer in a muffler of the motor vehicle which prevents a swaying and has the function of a stabilizer which couples wheels on two sides of the motor vehicle to each other. In a simple embodiment, such a stabilizer is a simple spring. When the rigidity of the stabilizer, namely the spring, is changed, the wheel load i.e. force on the wheel which acts along the vertical axis of the vehicle, also changes. The rigidity can be changed in that an actuator is coupled in between two spring parts.

The wheel load can also be changed in the region of a muffler by an open loop control, and further regulating variables can be defined for example at a superimposed steering or a rear axle steering.

In a preferred embodiment of the invention, the change with regard to the setting at the chassis device occurs such that a variable which describes the self-steering behavior of the motor vehicle takes on a predetermined value which depends on the drive mode.

Preferably this value is the self-steering gradient.

Thus, it can be determined to what degree the motor vehicle over-steers, drives normally or under-steers, namely in a defined manner and this in dependence on the drive mode.

It is possible that the dependence on the drive mode is expressed in that the value namely in particular the self-steering gradient, is in each case different. Thus, for example, a stronger under-steering may be more useful for a rear drive than for a front wheel drive (Front drive) because in case of a rear wheel drive, an immanent over-steering is given anyway by the drive forces. Insofar there is an intended difference in the self-steering gradient in dependence on the drive mode.

As an alternative, it is possible on the other hand, that the self-steering gradient changes as little as possible when changing the drive mode, namely at most 15%, preferably at most 10%, particularly preferably at most 5%, especially preferably at most 2 or 1.5% or 1%. In this case, the driver has always the impression, that the motor vehicle behaves as before, even when the drive mode has changed. Then, the driver does not have to adapt to the change in the drive mode and he can safely drive the motor vehicle.

The motor vehicle according to the invention uses an active chassis device, i.e. a vehicle body device at which adjustments can be carried out automatically. A control device can cause an automatic change to occur with regard to at least one adjustment which is possible at the chassis device of the motor vehicle when the drive mode is changed.

The motor vehicle according to the invention has thus an active chassis device which is assigned a control device which is configured to automatically carry out the method, wherein preferred embodiments of the method are also preferably implemented by the control device.

In the following, a preferred embodiment of the invention is described with reference to the drawing, in which

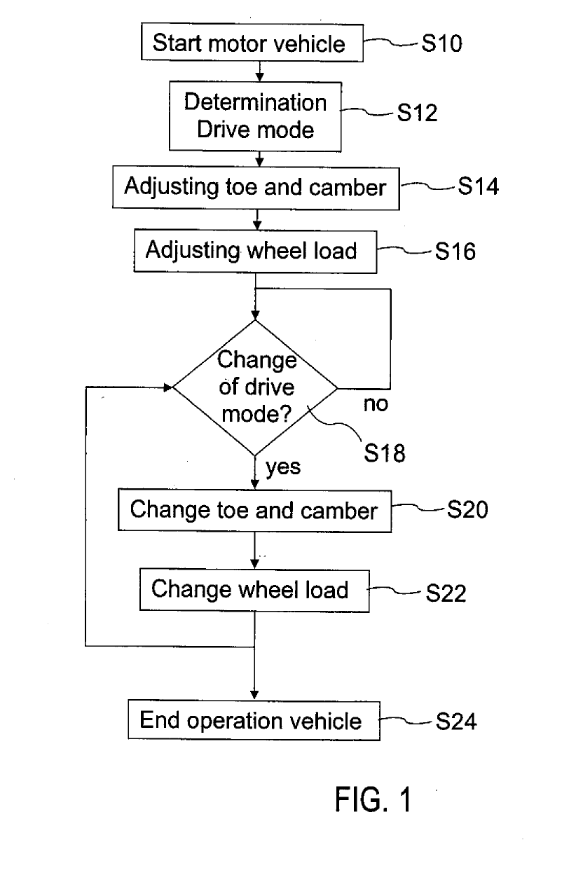

FIG. 1 shows a flow chart for explaining an embodiment of the method according to the invention.

With a start of a motor vehicle in step S10, the vehicle driver or a control system of the motor vehicle determines in step S12 in which drive mode to start the drive. The drive mode can for example be a rear wheel drive, a front wheel drive or an all wheel drive. Principally, two drive modes differ with regard to at least one wheel of the motor vehicle in that whether it is driven or not. The motor vehicle in the present case is to enable at least two such drive modes. Matching this drive mode, the camber and toe-in are adjusted in step S14, and the wheel load on the wheels is adjusted according to step S16, for example at a so called stabilizer, i.e. a spring which couples wheels on two sides of a motor vehicle to each other, the rigidity is accordingly adjusted.

In step 18, it is verified whether anything has changed with regard to the drive mode. This can be caused by the driver or by an automatic system.

So long as no change occurs in the drive mode, it is repeatedly verified whether the drive mode changes. As soon as the drive mode has changed according to step 18, the toe-in and camber are readjusted according to step S20 as close in time to the change as possible, and the wheel load is also readjusted according to step S22.

According to one embodiment, the goal is here that for motor vehicle to have the same self-steering angle in all drive modes, i.e. the same ratio of steering angle to speed of the vehicle when driving in a circle with a constant radius. As an alternative, the goal may be to set the self-steering gradient in a defined manner in accordance with each respective drive mode in order to ensure optimal safety depending on the drive mode. For example, the self-steering angle can be within the under-steering range, when the drive mode corresponds to a rear wheel drive.

After completing step S22, step S18 is repeated and it is verified whether the drive mode has changed or is to be changed, until this is the case again and steps S20 and S22 are repeated. At some point, step S24 branches off the flow chart, according to which step the operation of the vehicle is stopped i.e., the vehicle is brought to a standstill or is turned off.

The invention optimally adjusts the camber and toe-in and wheel load in each case in accordance with the drive mode, so that the vehicle driver can safely drive the vehicle, namely either because he optimally knows its self-steering behavior and can assess the same, or because the self-steering behavior is optimally adjusted to the drive mode.

1.-8. (canceled)

9. A method for operating a motor vehicle, which is drivable in one of at least two drive modes, which differ from one another with regard to at least one wheel of the motor vehicle regarding whether the at least one wheel it is driven or not, comprising:
automatically changing a setting of a chassis device of the motor vehicle in response to changing the drive mode so that a variable which describes a self-steering behavior of the motor vehicle corresponds to a predetermined value, said predetermined value being a function of the drive mode.

10. The method of claim 9, wherein the changing step includes changing a camber angle and/or a toe-in angle at at least one wheel of the motor vehicle.

11. The method of claim 9, wherein the changing step includes changing a wheel load at at least one wheel on which the wheel load acts along a vertical axis of the motor vehicle.

12. The method of claim 9, wherein the changing step includes changing a rigidity of a stabilizer which couples wheels arranged at two respective sides of the motor vehicle to one another.

13. The method of claim 9, wherein the variable is a self-steering gradient.

14. The method of claim 13, wherein the self-steering gradient changes by at most 15%.

15. The method of claim 13, wherein the self-steering gradient changes by at most 10%.

16. The method of claim 13, wherein the self-steering gradient changes by at most 5%.

17. The method of claim 13, wherein the self-steering gradient changes by at most 1%.

18. A motor vehicle which is drivable in one of at least two drive modes, which differ from one another with regard to at least one wheel of the motor vehicle regarding whether the wheel is driven or not, comprising:
a chassis device; and
a control device which automatically changes at least one setting at the chassis device in response to a change of the drive mode, so that a variable which describes a self-steering behavior of the motor vehicle corresponds to a predetermined value, said predetermined value being a function of the drive mode.
